(19) United States
(12) Patent Application Publication
(10) Pub. No.: US 2024/0211825 A1
(43) Pub. Date: Jun. 27, 2024

(54) JOB-SHOP BATCH SCHEDULING METHOD BASED ON D3QN AND GENETIC ALGORITHM

(71) Applicant: Hangzhou Dianzi University, Hangzhou (CN)

(72) Inventors: Yifan Wu, Hangzhou (CN); Zhiqiang Wang, Hangzhou (CN); Tingcong Ye, Hangzhou (CN); Yanping Xu, Hangzhou (CN); Hua Zhang, Hangzhou (CN); Guojun Dai, Hangzhou (CN)

(73) Assignee: Hangzhou Dianzi University, Hangzhou, ZH (CN)

(21) Appl. No.: 18/537,969

(22) Filed: Dec. 13, 2023

(30) Foreign Application Priority Data
Dec. 14, 2022 (CN) 202211609644.1

(51) Int. Cl. G06Q 10/0631; G06N 3/04; G06N 3/086

(52) U.S. Cl. CPC G06Q 10/06311; G06N 3/04; G06N 3/086

(57) ABSTRACT

Disclosed in the present disclosure is a job-shop batch scheduling method based on a dueling double deep Q-network (D3QN) and a genetic algorithm. The present disclosure includes: constructing a mathematical model of a job-shop batch scheduling problem, where a goal of scheduling is to minimize a maximum completion time; determining a batch partition solution to the job-shop batch scheduling problem by the genetic algorithm; crossing and mutating chromosomes in a population; decoding the chromosomes, and obtaining a batch division solution of the workpieces to be machined; and expressing a procedure sequencing problem of the workpiece batches as a disjunctive graph model; performing representative learning on node feature information of a disjunctive graph by using a graph neural network, and extracting a feature state of the procedure sequencing problem; designing a D3QN model structure with priority experience replay, and training the D3QN model; and determining whether a termination condition is satisfied.

### CROSS REFERENCE TO RELATED APPLICATION

This patent application claims the benefit and priority of Chinese Patent Application No. 202211609644.1, filed with the China National Intellectual Property Administration on Dec. 14, 2022, the disclosure of which is incorporated by reference herein in its entirety as part of the present application.

### TECHNICAL FIELD

The present disclosure belongs to the field of intelligent production scheduling, and provides a job-shop batch scheduling method based on a D3QN and a genetic algorithm.

### BACKGROUND

The manufacturing industry, the pillar industry of national economy, embodies the comprehensive national power. The manufacturing industry has been gradually transformed towards intelligence and digitalization. Shop scheduling is an important part of a manufacturing process. How to accomplish an efficient and intelligent scheduling system is one of the keys to improve the competitiveness of an enterprise. The job-shop scheduling problem is the current focus of studies in the field of shop production scheduling. Most studies on the job-shop scheduling problem focus on individual workpieces, whereas in actual production, a batch scheduling pattern is typically used to improve scheduling efficiency and reduce costs. Therefore, the study on the job-shop batch scheduling problem is of great practical significance for improving enterprise production efficiency, reducing costs and gaining more economic benefits.

The job-shop batch scheduling problem needs to solve two sub-problems, i.e., batch division and procedure sequencing, which greatly increases the complexity of the problem as well as the search space of solutions. In recent years, domestic and foreign scholars have mostly used a genetic algorithm to solve the job-shop batch scheduling problem. The prior art suffers from the following shortcomings. 1. The batch scheduling problem is complex and the solution space is huge, so it is difficult for the genetic algorithm to find an ideal solution in a limited time. 2. In view of different batch division solutions, the genetic algorithm needs to resolve the procedure sequencing problem of the workpiece batches by iterating again, which has poor generalization.

In recent years, deep reinforcement learning has achieved great results in the field of combinatorial optimization such as the traveler's problem and the path optimization problem. Therefore, applying deep reinforcement learning to the scheduling problem is a novel research direction. As far as we know, no research using deep reinforcement learning to solve the job-shop batch scheduling problem has been conducted. The dueling double deep Q-network (D3QN) algorithm is a novel deep reinforcement learning algorithm that combines the advantages of the Dueling DQN and Double DQN algorithms and further improves the traditional DQN algorithm. The present disclosure utilizes the D3QN algorithm to solve the procedure sequencing problem for the workpiece batches so as to quickly obtain a better adaptive scheduling strategy. Therefore, the maximum completion time is optimized, and the speed of solving the job-shop batch scheduling problem is significantly increased.

### SUMMARY

In view of the defects in the prior art, the present disclosure provides a job-shop batch scheduling method based on the dueling double deep Q-network (D3QN) and a genetic algorithm. The method uses a layered iterative optimization strategy. The batch division solution of a job-shop batch scheduling task is determined by a genetic algorithm in the outer layer, based on which, a trained D3QN model is used for providing an adaptive scheduling strategy for batch procedure sequencing problem in the outer layer, such that the completion time of the job-shop batch scheduling task is minimized, and the production efficiency is improved.

To achieve the above objectives, a technical solution used in the present disclosure includes:
S1: constructing a mathematical model of a job-shop batch scheduling problem according to a number of machines in a manufacturing shop, types of workpieces to be machined, and a number of each type of workpieces to be machined, where a goal of scheduling is to minimize a maximum completion time;
S2: determining a batch division solution to the job-shop batch scheduling problem by the genetic algorithm: dividing each type of workpieces into a plurality of batches with different sizes based on a coding form of a real number sequence randomly, combining the batches, and generating an initial population;
S3: increasing diversity of the initial population by crossing and mutating chromosomes in the initial population;
S4: decoding the chromosomes, and obtaining a batch division solution of the workpieces to be machined; and expressing a procedure sequencing problem of the workpiece batches after workpiece batch division as a disjunctive graph model, establishing a Markov decision process based on the disjunctive graph model, and designing a state, an action and a reward of the Markov decision process;
S5: performing representative learning on node feature information of an obtained disjunctive graph by using a graph neural network, capturing an implicit relation between procedures, and effectively extracting a feature state of the procedure sequencing problem;
S6: designing a D3QN model with priority experience replay, training the D3QN model, providing an adaptive scheduling strategy and completion time for the procedure sequencing problem of the workpiece batches after workpiece batch division, and taking a reciprocal of the completion time as a fitness function value of the genetic algorithm; and
S7: determining whether an iteration of the genetic algorithm satisfies a termination condition, if yes, outputting an optimal batch division solution and a scheduling strategy of the job-shop batch scheduling problem; and otherwise, selecting an optimal individual from the population through a roulette method to enter a next generation, and executing S3.

In S1, the mathematical model for job-shop batch scheduling is constructed as follows:
1-1. the job-shop batch scheduling problem is described as follows: supposing n types of workpieces to be machined on M machines in a shop, each type of workpieces is divided into a plurality of batches, a number of workpieces in each batch is randomly assigned, each batch of each type of workpieces includes J procedures, machining machines and a machining time of each procedure are known, a scheduling goal is to divide the workpieces in batches reasonably and arrange a machining order of the procedures of each batch, so as to minimize the maximum completion time;
1-2. symbols used in the mathematical model of the job-shop batch scheduling problem are described as follows:
n: number of types of workpieces to be machined;
m: a machining machine no., and m=1, 2, 3, . . . , M;
j: a procedure no. of workpieces i;
Jᵢ: a total number of procedures of the workpieces i;
k: a batch no. of the workpieces i;
Bᵢ: a total number of the workpieces i;
Aₘₐₓ: a maximum number of batches of all workpieces;
Pᵢ: a number of batches of the workpieces i;
Sᵢₖ: a number of the workpieces i in the kth batch;
Oₜⱼ: a jth procedure of the workpieces i;
PTᵢⱼₘ: a time of machining of the jth procedure of the workpieces i on the machine m;
ST_{ikym}: a start time of machining of the jth procedure of the workpieces i in the kth batch on the machine m;
ETiₖⱼₘ: an end time of machining of the jth procedure of the workpieces i in the kth batch on the machine m;
Eᵢₖₘ: an end time of machining of a last procedure of the workpieces i in the kth batch on the machine m;
Xᵢⱼₘ: a decision variable, which is 1 in case that the jth procedure of the workpieces i is machined on the machine m, and is 0 otherwise;
Cᵢ: a finish time of the workpieces i; and
Cₘₐₓ: a maximum completion time for all workpieces; and
1-3. according to definitions of the symbols, the mathematical model of the job-shop batch scheduling problem is established as follows:
an objective function is as follows:

$$min {C}_{max} = min max \{ {C}_{i} \vert i = 1 , 2 , … , n \} \qquad ( 1 )$$

constraint conditions are as follows:

$${\sum }_{k = 1}^{{P}_{i}} {S}_{ik} = {B}_{i} \qquad ( 2 )$$

$$1 \leq {P}_{i} \leq {A}_{max} \qquad ( 3 )$$

$${ET}_{ikjm} = {ST}_{ikjm} + {PT}_{ijm} \times {S}_{ik} \qquad ( 4 )$$

$${ST}_{ik ( j + 1 ) m} >= {ET}_{ikjm} \qquad ( 5 )$$

$${\sum }_{m = 1}^{M} {X}_{ijm} = 1 \qquad ( 6 )$$

$${C}_{max} = max \{ {C}_{i} \vert i = 1 , 2 , … , n \} \qquad ( 7 )$$

Equation (1) indicates a minimum completion time after model optimization; equation (2) indicates that the sum of numbers of workpieces i in all batches must be equal to a total number of the workpieces i; equation (3) indicates that a number of batches divided is not greater than a pre-specified maximum number; equation (4) indicates that an end time of the jth procedure of the workpieces i in the kth batch on the machine m is equal to a sum of the start time of machining and a procedure machining time of the batch, where the procedure machining time of the batch is a product of a procedure machining time and a number of the workpieces in that batch; equation (5) indicates that a same workpiece is only machined after being machined in a previous procedure; equation (6) indicates that the jth procedure of the workpieces i is only performed on one machine; and equation (7) indicates that the maximum completion time is equal to a maximum finish time of all workpieces.

In S3, crossing is to randomly generate an integer r (1≤r≤n), exchange chromosome genes corresponding to a workpiece numbered r in two parent chromosomes, and obtain two new chromosomes.

In S3, mutating is to randomly generate an integer r (1≤r≤n), randomly selecting two positions of the chromosome genes corresponding to the workpiece numbered r, perform operations of adding 1 and subtracting 1, and obtain a new chromosome.

In S4, the disjunctive graph model of the procedure sequencing problem is constructed as follows:
4-1. a disjunctive graph G=(V,C∪D) is a mixed graph, where V represents a set of all machining procedure nodes; C represents a set of connecting arcs, that is, an order constraint relation between different procedures of a same workpiece; D represents a set of disjunctive arcs, and two procedure nodes connected to a same disjunctive arcs is machined on a same machine; and scheduling is regarded as determining a direction of all the disjunctive arcs in the graph and further minimizing the maximum completion time; and
4-2. according to a real-time state of a scheduling process, the following feature information is added to each procedure node in the disjunctive graph:
(1) a procedure state which is represented by a one-hot vector, where [1, 0, 0] means not completed, [0, 1, 0] means being machined, and [0, 0, 1] means completed;
(2) a procedure machining time;
(3) an estimated procedure finish time;
(4) a procedure waiting time;
(5) a remaining procedure machining time; and
(6) a workpiece procedure completion rate; and
time-related data are normalized, and values of the time-related data are mapped to [0, 1].

In S4, designing of the actions is to take 8 heuristic rules (FIFO, LIFO, MOR, LOR, LPT, SPT, LTPT and STPT) as an action space.
In S4, designing of the rewards is specifically calculated as follows:

$${r}_{t} = \{ \begin{matrix}{U}_{t} - {U}_{t - 1} & t \neq 1 \\ {U}_{t} - {U}_{t - 1} - ( makespan - {T}_{ini} ) / C & t = L\end{matrix}$$

where Uₜ represents a utilization rate of a machining machine at a moment t through a calculation method: a machining machine utilization rate=a total working time of the machine/(a current time-a time when a first procedure starts); and C is a constant related to a scheduling scale, make span is an actual completion time of finishing all workpieces machined on this machine, Tᵢₙᵢ is an initial estimated completion time through a calculation method:

$${T}_{ini} = max ( {\sum }_{for all j} {T}_{i , j} , i ∈ ( 0 , 1 , 2 , … , n ) ) ,$$

and L is the completion time of the scheduling.

In S5, representative learning is performed on the node feature information of the disjunctive graph by using the graph neural network, and a node representative calculation method is as follows:

$${h}_{v}^{( k )} = {f}_{θ}^{( k )} ( {f}_{o}^{( k )} ( {\sum }_{u ∈ {N}_{o} ( v )} {h}_{o}^{( k - 1 )} ) ‖ {f}_{d}^{( k )} ( {\sum }_{u ∈ {N}_{d} ( v )} {h}_{d}^{( k - 1 )} ) ‖ {h}_{v}^{( k - 1 )} )$$

where hᵥ^{(k)} represents a kth-generation node feature of a target node v, hₒ represents a connecting arc node feature, and h_{d} represents a disjunctive arc node feature; f_{θ} represents an updating function of the target node v, fₒ represents a connecting arc node updating function, and f_{d} represents a disjunctive arc node updating function; ∥ represents a vector connector; and after K iterations, each node in the disjunctive graph includes a feature state of K-hop neighbor nodes, all of the node features in the graph are summed and averaged, and a feature state, that is, h_{G}=Σ_{u∈V}kᵥ^{K}/|V|, of the disjunctive graph is obtained.

In S6, the training the D3QN model, and providing an adaptive scheduling strategy and completion time for the procedure sequencing problem of the workpiece batches after workpiece batch division specifically include:
6-1. initializing parameters: initializing a parameter θ of a current Q network, initializing a parameter θ⁻ of a target \hat{Q} network, and assigning the parameter of the Q network to the target \hat{Q} network, where θ→θ⁻, a total number of iteration rounds is T, a discount factor is γ, an exploration rate is ∈, an update frequency of the parameter of the target \hat{Q} network is P, an experience replay capacity is N, and priority experience replay parameters are α and β;
6-2. inputting a current state s into a D3QN, calculating a corresponding Q value of each action, and selecting an action a by means of a ∈-greedy algorithm, such that a system gives a reward r;
6-3. storing the current state s, the action a, the reward r and a next state s′ obtained in a training process into a priority experience replay pool in a form of quadruples (s, a, r, s′) which provide experience data for a subsequent scheduling decision;
6-4. selecting min-batch samples from an experience pool M through a priority experience replay method, and training the min-batch samples, where a probability that a sample j is selected is calculated as follows

$$j \sim P ( j ) = \frac{{p}_{j}^{α}}{{Σ}_{k} {p}_{k}^{α}}$$

where α represents a priority weight, uniform sampling is performed when α=0, pⱼ represents a priority index whose value is related to |TD-error|, and a specific calculation formula of pⱼ is as follows:

$${δ}_{j} = {r}_{j} + γ \hat{Q} ( {s}_{j} , arg {max}_{a} Q ( {s}_{j + 1} , {a}_{j} ) ) - Q ( {s}_{j} , {a}_{j} ) \\ {P}_{j} = \vert {δ}_{j} \vert + ∈$$

where δⱼ is a time difference error TD-error, ∈ is a small positive number that prevents a sampling probability from approaching zero and is configured to guarantee that all samples have a probability of being selected;
when priority sampling is performed, different samples are assigned different probabilities, an original desired distribution is changed accordingly, importance sampling is configured to eliminate a deviation, and the weight of the importance sampling is calculated as follows:

ωⱼ=(N•Pⱼ)^{-β}/maxᵢωᵢ
where β is a hyperparameter configured to adjust a degree of the deviation; and
data obtained by sampling are input into the D3QN model, a time difference error TD-error is calculated, and a priority in a priority replay experience mechanism is further updated;
6-5. calculating a loss function, and updating a weight parameter of the D3QN continuously through a random gradient descent method, where a calculation method of the loss function is as follows:

$$L = {( r + γ \hat{Q} ( {s}^{′} , arg {max}_{a ∈ A} Q ( {s}^{′} , a ; θ ) ; {θ}^{-} ) - Q ( s , a ; θ ) )}^{2}$$

where γ represents a discount factor; and
6-6. obtaining a final scheduling model of the procedure sequencing problem by training cyclically until cumulative rewards are converged. The trained model supports a fast solution to the procedure sequencing problem and can adapt to procedure sequencing problems of different scales with desirable generalization.

Compared with the prior art, the present disclosure has the following advantages and effects.
1. In the present disclosure, the job-shop batch scheduling problem is decomposed into two sub-problems of batch division and batch procedure sequencing. The layered iterative optimization strategy is used to solve the two sub-problems. Therefore, complexity of the problem is reduced. The batch division solution of the workpieces is determined by using the genetic algorithm, and the procedure sequencing problem of the workpiece batches is solved by using the trained D3QN model, such that a high-quality scheduling strategy can be obtained in a short time.
2. In the present disclosure, the disjunctive graph is subjected to representative learning through the graph neural network, and an effective graph node representative calculation method is designed to adapt to different scheduling environments, such that the D3QN model obtained by training has desirable generalization ability. That is to say, a model obtained by training under small-scale problems can be directly used for large-scale problems without repeated training.
3. The method designed in the present disclosure is superior to existing method that uses solely genetic algorithm in solving effect under the same iterations. The method is one order of magnitude faster in solving speed since the genetic algorithm needs to resolve the procedure sequencing problem of the workpiece batches by iterating again, which is very time-consuming. The D3QN model trained by the present disclosure can provide a better scheduling strategy for the procedure sequencing problem of the workpiece batches in a millisecond-class time.

### BRIEF DESCRIPTION OF THE DRAWINGS

FIG. 1 is a block diagram of a job-shop batch scheduling method based on a dueling double deep Q-network (D3QN) and a genetic algorithm;

FIG. 2 is a schematic diagram of chromosome coding, crossing and mutation in a genetic algorithm;

FIGS. 3A-B are 3×3 disjunctive graph model for a procedure sequencing problem; and

FIG. 4 is a structural diagram of a graph neural network combined with a D3QN model.

### DETAILED DESCRIPTION OF THE EMBODIMENTS

To make the objectives, technical solutions and advantages of the present disclosure clearer, the present disclosure will be further described in detail below with reference to the accompanying drawings and embodiments.

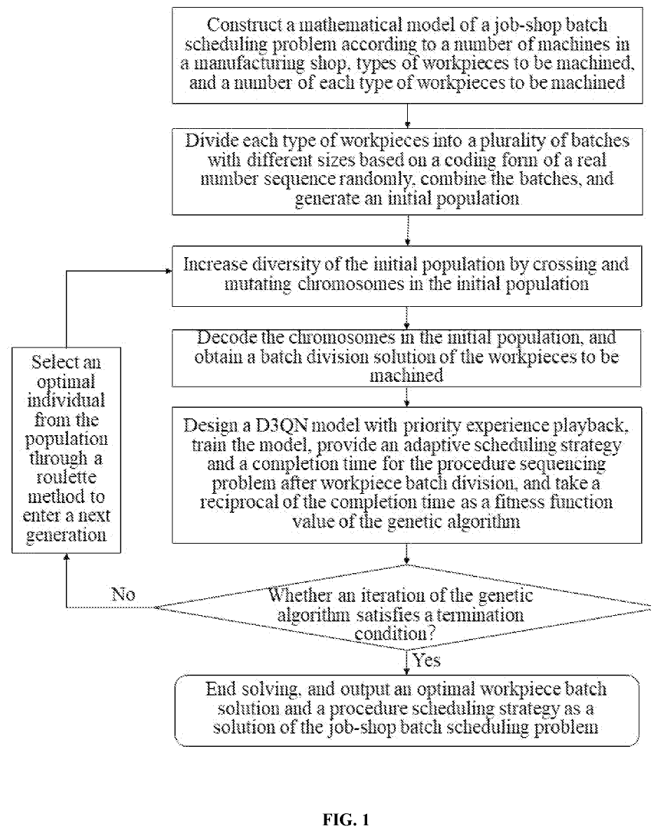

FIG. 1 is a block diagram showing how to solve a job-shop batch scheduling problem using a method based on a dueling double deep Q-network (D3QN) and a genetic algorithm. The embodiment of the present disclosure provides a job-shop batch scheduling method based on a D3QN and a genetic algorithm. The method specifically includes:
S1: construct a mathematical model of a job-shop batch scheduling problem according to a number of machines in a manufacturing shop, types of workpieces to be machined, and a number of each type of workpieces to be machined, where a goal of scheduling is to minimize a maximum completion time. It includes the following steps:
1) Describe the job-shop batch scheduling problem as follows: supposing n types of workpieces to be machined on M machines in a shop, each type of workpieces is divided into a plurality of batches, a number of workpieces in each batch is randomly assigned, each batch of each type of workpieces includes J procedures, machining machines and a machining time of each procedure are known, a scheduling goal is to divide the workpieces in batches reasonably and arrange a machining order of the procedures of each batch, so as to minimize the maximum completion time.
2) Provide symbolic definitions of the model according to the above problem description:
n: number of types of workpieces to be machined;
m: a machining machine no., and m=1, 2, 3, . . . , M;
j: a procedure no. of workpieces i;
Jᵢ: a total number of procedures of the workpieces i;
k: a batch no. of the workpieces i;
Bᵢ: a total number of the workpieces i;
Aₘₐₓ: a maximum number of batches of all workpieces;
Pᵢ: a number of batches of the workpieces i;
Sᵢₖ: a number of the workpieces i in the kth batch;
Oₜⱼ: a jth procedure of the workpieces i;
PTᵢⱼₘ: a time of machining of the jth procedure of the workpieces i on the machine m;
ST_{ikym}: a start time of machining of the jth procedure of the workpieces i in the kth batch on the machine m;
ETᵢₖⱼₘ: an end time of machining of the jth procedure of the workpieces i in the kth batch on the machine m;
Eᵢⱼₘ: an end time of machining of a last procedure of the workpieces i in the kth batch on the machine m;
Xᵢⱼₘ: a decision variable, which is 1 in case that the jth procedure of the workpieces i is machined on the machine m, and is 0 otherwise;
Cᵢ: a finish time of the workpieces i; and
Cₘₐₓ: a maximum completion time for all workpieces; and
(3) According to the above symbolic definitions, establish the following mathematical model for the job-shop batch scheduling problem:
an objective function is as follows:

$$min {C}_{max} = min max \{ {C}_{i} \vert i = 1 , 2 , … , n \} \qquad ( 8 )$$

constraint conditions are as follows:

$${\sum }_{k = 1}^{{P}_{i}} {S}_{ik} = {B}_{i} \qquad ( 9 )$$

$$1 \leq {P}_{i} \leq {A}_{max} \qquad ( 10 )$$

$${ET}_{ikjm} = {ST}_{ikjm} + {PT}_{ijm} \times {S}_{ik} \qquad ( 11 )$$

$${ST}_{ik ( j + 1 ) m} >= {ET}_{ikjm} \qquad ( 12 )$$

$${\sum }_{m = 1}^{M} {X}_{ijm} = 1 \qquad ( 13 )$$

$${C}_{max} = max \{ {C}_{i} \vert i = 1 , 2 , … , n \} \qquad ( 14 )$$

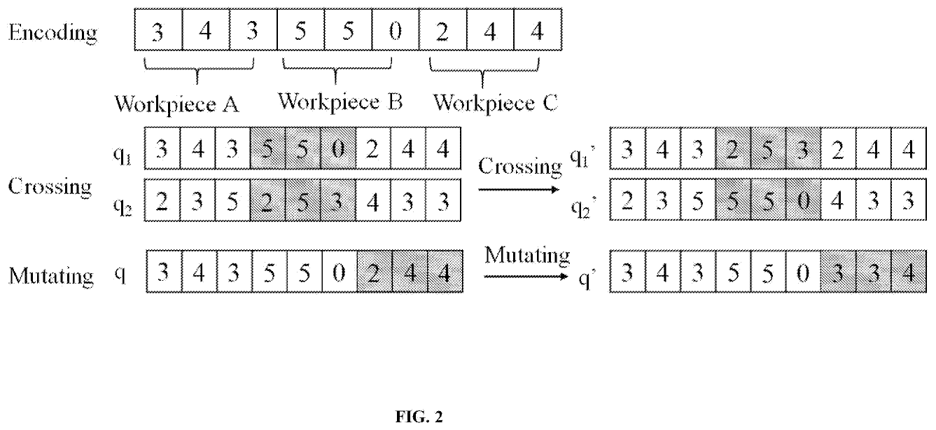

Equation (1) indicates a minimum completion time after model optimization. Equation (2) indicates that the sum of numbers of workpieces i in all batches must be equal to a total number of the workpieces i. Equation (3) indicates that a number of batches divided is not greater than a pre-specified maximum number. Equation (4) indicates that an end time of the jth procedure of the workpieces i in the kth batch on the machine m is equal to a sum of the start time of machining and a procedure machining time of the batch, where the procedure machining time of the batch is a product of a procedure machining time and a number of the workpieces in that batch. Equation (5) indicates that a same workpiece is only machined after being machined in a previous procedure. Equation (6) indicates that the jth procedure of the workpieces i is only performed on one machine. Equation (7) indicates that the maximum completion time is equal to a maximum finish time of all workpieces.
S2: determine a batch division solution to the job-shop batch scheduling problem by the genetic algorithm: divide each type of workpieces into a plurality of batches with different sizes based on a coding form of a real number sequence randomly, combine the batches, and generate an initial population. As shown in FIG. 2, a code (3, 4, 3, 5, 5, 0, 2, 4, 4) refers to dividing workpieces A, B, and C into at most three batches. A specific solution is as follows: workpiece A is divided into three batches which include 3, 4, and 3 workpieces A respectively, workpiece B is divided into two batches which include 5 workpieces B and 5 workpieces B respectively, and workpiece C is divided into three batches which include 2, 4, and 4 workpieces C respectively.
S3: increase diversity of the initial population by crossing and mutating chromosomes in the initial population; and decode the chromosomes, and obtain a batch division solution of the workpieces to be machined.
Crossing is to randomly generate an integer r (1≤r≤n), exchange chromosome genes corresponding to a workpiece numbered r in two parent chromosomes, and obtain two new chromosomes. As shown in FIG. 2, the crossing indicates that a randomly generated r=2, and chromosome genes corresponding to workpieces numbered 2 in two parent chromosomes q₁ and q₂ are exchanged to obtain two chromosomes q₁′ and q₂′.

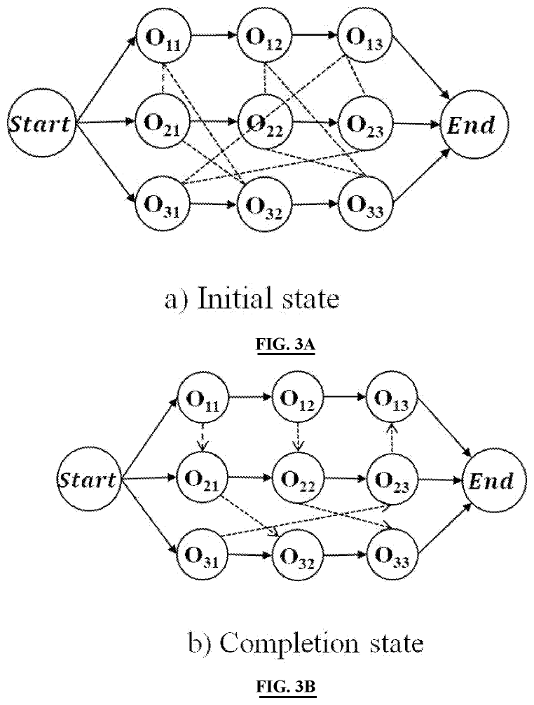

Mutating is to randomly generate an integer r (1≤r≤n) randomly selecting two positions of the chromosome genes corresponding to the workpiece numbered r, perform operations of adding 1 and subtracting 1, and obtain a new chromosome. As shown in FIG. 2, the mutating indicates that randomly generated r=3, and position 1 and position 2 are selected from a chromosome gene corresponding to a workpiece numbered 3 in a chromosome q and subjected to the operation of adding 1 and subtracting 1, and a new chromosome q′ is obtained.
S4: express a procedure sequencing problem of the workpiece batches after workpiece batch division as a disjunctive graph model, establish a Markov decision process based on the constructed disjunctive graph model of the procedure sequencing problem, and design a state, an action and a reward of the Markov decision process. A specific process is as follows:
1) A disjunctive graph G=(V,C∪D) is a mixed graph, where V represents a set of all machining procedure nodes. C represents a set of connecting arcs, that is, an order constraint relation between different procedures of a same workpiece. D represents a set of disjunctive arcs, and two procedure nodes connected to a same disjunctive arcs is machined on a same machine. Scheduling is regarded as determining a direction of all the disjunctive arcs in the graph and further minimizing the maximum completion time. FIGS. 3A-B are disjunctive graph model for the procedure sequencing problem.
2) According to a real-time state of a scheduling process, the following feature information is added to each procedure node in the disjunctive graph: (1) a procedure state which is represented by a one-hot vector, where [1, 0, 0], means not completed, [0, 1, 0] means being machined, and [0, 0, 1] means completed; (2) a procedure machining time; (3) an estimated procedure finish time; (4) a procedure waiting time; (5) a remaining procedure machining time; and (6) a workpiece procedure completion rate; and time-related data are normalized, and values of the time-related data are mapped to [0, 1], such that a variance is reduced, and robustness of the model is improved.
3) The actions refer to taking 8 heuristic rules (FIFO, LIFO, MOR, LOR, LPT, SPT, LTPT and STPT) as an action space.
4) The rewards in S4 are specifically calculated as follows:

$${r}_{t} = \{ \begin{matrix}{U}_{t} - {U}_{t - 1} & t \neq 1 \\ {U}_{t} - {U}_{t - 1} - ( makespan - {T}_{ini} ) / C & t = L\end{matrix}$$

where Uₜ represents a utilization rate of a machining machine at a moment t through a calculation method: a machining machine utilization rate=a total working time of the machine/(a current time-a time when a first procedure starts). C is a constant related to a scheduling scale. make span is an actual completion time of finishing all workpieces machined on this machine. Tᵢₙᵢ is an initial estimated completion time through a calculation method:

$${T}_{ini} = max ( {\sum }_{for all j} {T}_{i , j} , i ∈ ( 0 , 1 , 2 , … , n ) ) .$$

L is the completion time of the scheduling.
S5: perform representative learning on node feature information of a disjunctive graph by using a graph neural network, capture an implicit relation between procedures, and effectively extract a feature state of the procedure sequencing problem.

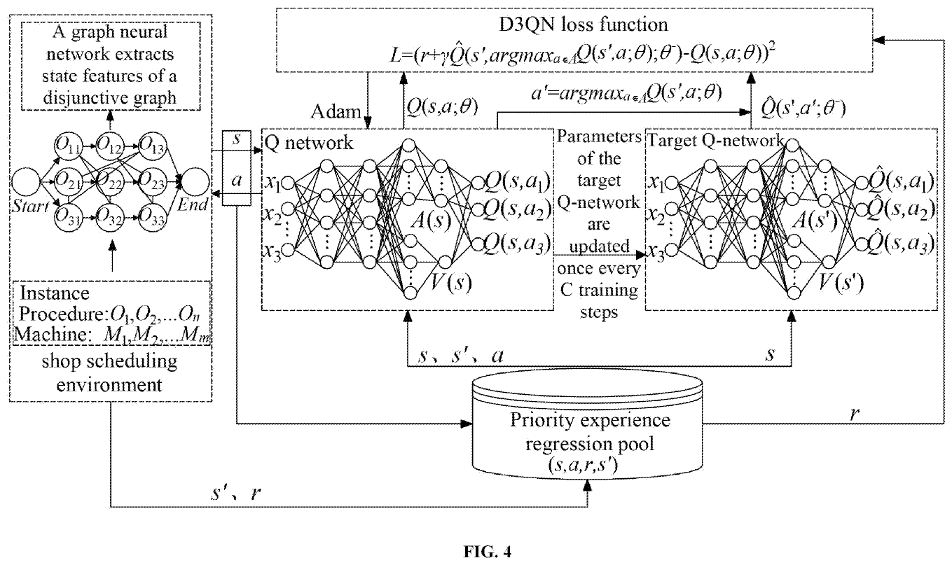

In the step, representative learning is performed on the node feature information of the disjunctive graph by using the graph neural network, and a specific node representative calculation method is as follows:

$${h}_{v}^{( k )} = {f}_{θ}^{( k )} ( {f}_{o}^{( k )} ( {\sum }_{u ∈ {N}_{o} ( v )} {h}_{o}^{( k - 1 )} ) ‖ {f}_{d}^{( k )} ( {\sum }_{u ∈ {N}_{d} ( v )} {h}_{d}^{( k - 1 )} ) ‖ {h}_{v}^{( k - 1 )} )$$

where kᵥ^{(k)} represents a kth-generation node feature of a target node v. hₒ represents a connecting arc node feature, and h_{d} represents a disjunctive arc node feature. f_{θ} represents an updating function of the target node v, fₒ represents a connecting arc node updating function, and f_{d} represents a disjunctive arc node updating function. II represents a vector connector. After K iterations, each node in the disjunctive graph includes a feature state of K-hop neighbor nodes, all of the node features in the graph are summed and averaged, and a feature state, that is, h_{G}=Σ_{u∈V}hᵥ^{K}/|V|, of the disjunctive graph is obtained.
S6: design a D3QN model structure with priority experience replay, train the model, provide an adaptive scheduling strategy and completion time for the procedure sequencing problem of the workpiece batches after workpiece batch division, and take a reciprocal of the completion time as a fitness function value of the genetic algorithm. FIG. 4 is a block diagram of the D3QN model. A training process of the D3QN model is as follows:
1) Initialize parameters: initialize a parameter θ of a current Q network, initialize a parameter θ⁻ of a target \hat{Q} network, and assign the parameter of the Q network to the target \hat{Q} network, where θ→θ⁻, a total number of iteration rounds is T, a discount factor is γ, an exploration rate is ∈, an update frequency of the parameter of the target \hat{Q} network is P, an experience replay capacity is N, and priority experience replay parameters are α and β.
2) Input a current state s into a D3QN, calculate a corresponding Q value of each action, and select an action a by means of a ∈-greedy algorithm, such that a system gives a reward r
3) Store the current state s, the action a, the reward r and a next state s′ obtained in a training process into a priority experience replay pool in a form of quadruples (s, a, r, s′) which provide experience data for a subsequent scheduling decision.
4) Select min-batch samples from an experience pool M through a priority experience replay method, and train the min-batch samples. A probability that a sample j is selected is calculated as follows:

$$j \sim P ( j ) = \frac{{p}_{j}^{α}}{{\sum }_{k} {p}_{k}^{α}}$$

where α represents a priority weight, uniform sampling is performed when α=0, pⱼ represents a priority index whose value is related to |TD-error|, and a specific calculation formula of pⱼ is as follows

$${δ}_{j} = {r}_{j} + γ \hat{Q} ( {s}_{j} , arg {max}_{a} Q ( {s}_{j + 1} , {a}_{j} ) ) - Q ( {s}_{j} , {a}_{j} ) \\ Pj = \vert δ j \vert + ∈$$

where δⱼ is a time difference error TD-error, ∈ is a small positive number that prevents a sampling probability from approaching zero and is configured to guarantee that all samples have a probability of being selected.

When priority sampling is performed, different samples are assigned different probabilities, an original desired distribution is changed accordingly, importance sampling is configured to eliminate a deviation, and the weight of the importance sampling is calculated as follows:

$${ω}_{j} = {( N \cdot {P}_{j} )}^{- β} / {max}_{i} {ω}_{i}$$

where β is a hyperparameter configured to adjust a degree of the deviation.

Data obtained by sampling are input into the D3QN model, a time difference error TD-error is calculated, and a priority in a priority replay experience mechanism is further updated.
5) Calculate a loss function, and update a weight parameter of the D3QN continuously through a random gradient descent method, where a calculation method of the loss function is as follows:

$$L = {( r + γ \hat{Q} ( {s}^{′} , arg {max}_{a ∈ A} Q ( {s}^{′} , a ; θ ) ; {θ}^{-} ) - Q ( s , a ; θ ) )}^{2}$$

where γ represents a discount factor.
6) Obtain a final scheduling model of the procedure scheduling problem by training cyclically until cumulative rewards are converged. The trained model supports a fast solution to the procedure sequencing problem and can adapt to procedure sequencing problems of different scales with desirable generalization.
S7: determine whether iterations are satisfied, if yes, output an optimal batch division solution and a scheduling strategy of the job-shop batch scheduling problem; and otherwise, select an optimal individual from the population through a roulette method to enter a next generation, and execute S3.

Effectiveness and practicability of the present disclosure are proved by means of a concrete job-shop batch scheduling instance. Table 1 is an instance of a scheduling problem of a job shop with a scale of 4×4. The scheduling problem has four types of workpieces which are machined on four machines. Each type has 10 workpieces. Each workpiece contains four procedures. Corresponding machining machines and machining times of each procedure are known.

TABLE 1
Instance of scheduling problem of job shop

| | | |
|---|---|---|
| Workpiece | Number | (Machine, Time) |

| | | | | | |
|---|---|---|---|---|---|
| 1 | 10 | (2, 5) | (1, 7) | (3, 8) | (4, 3) |
| 2 | 10 | (1, 4) | (2, 2) | (3, 6) | (4, 7) |
| 3 | 10 | (2, 7) | (4, 3) | (1, 8) | (3, 5) |
| 4 | 10 | (4, 3) | (2, 6) | (1, 5) | (3, 9) |

Solution steps using the method are as follows
1) initialize genetic algorithm parameters: a population size N=30, evolution generations T=50 a crossing probability p_{c}=0.8, a mutation probability pₘ=0.1, and current iterations t=1;
2) perform encoding with a real number sequence, and generate an initial population;
3) cross and mutate chromosomes;
3) obtain a batch division solution of workpieces by decoding, and provide an adaptive scheduling strategy and a maximum completion time for batch procedure sequencing by using a trained D3QN model based on a batch division result;
4) take a reciprocal of the maximum completion time as a fitness function value, and select N optimal individuals through a roulette method to enter a next generation population; and
5) determine t>=T, if yes, end the algorithm, output the best batch solution and scheduling strategy, and otherwise jump to step 3.

A maximum completion time obtained through the method is 322, and a batch number of each type of workpiece is (1,2,3,4), (1,1,1,7), (1,2,3,4), (2,2,3,3). A maximum completion time obtained by means of the genetic algorithm is 348. A maximum completion time obtained without batches is 360. It can be seen that the workpiece machining in batches is beneficial to improvement in production efficiency. Moreover, as for a solving time, it takes 936 seconds to obtain an ideal solution through the method provided in the present disclosure, and it takes 2 hours and 16 minutes to obtain an ideal solution by means of the genetic algorithm, which is about 8 times of the time of the method provided in the present disclosure.

From the results of the above embodiments, it can be concluded that the method can effectively solve the job-shop batch scheduling problem, and has higher solution accuracy than the genetic algorithm. Moreover, as for the solving time, it takes a lot of time to get an optimal solution by using the genetic algorithm. The method can get an optimal solution in a shorter time, which is one order of magnitude faster than the traditional genetic algorithm.

What is claimed is:

1-9. (canceled)

10. A job-shop batch scheduling method based on a dueling double deep Q-network (D3QN) and a genetic algorithm, comprising:
S1: constructing a mathematical model of a job-shop batch scheduling problem according to a number of machines in a manufacturing shop, types of workpieces to be machined, and a number of each type of workpieces to be machined, wherein a goal of scheduling is to minimize a maximum completion time;
S2: determining a batch division solution to the job-shop batch scheduling problem by the genetic algorithm: dividing each batch of workpieces into a plurality of batches with different sizes based on a coding form of a real number sequence randomly, combining the batches, and generating an initial population;
S3: increasing diversity of the initial population by crossing and mutating chromosomes in the initial population;
S4: decoding the chromosomes, and obtaining a batch division solution of the workpieces to be machined; and expressing a procedure sequencing problem of the workpiece batches after workpiece batch division as a disjunctive graph model, establishing a Markov decision process based on the disjunctive graph model, and designing a state, an action and a reward of the Markov decision process;
S5: performing representative learning on node feature information of an obtained disjunctive graph by using a graph neural network, capturing an implicit relation between procedures, and effectively extracting a feature state of the procedure sequencing problem of the workpiece batches after workpiece batch division;
S6: designing a D3QN model with priority experience replay, training the D3QN model, providing an adaptive scheduling strategy and completion time for the procedure sequencing problem of the workpiece batches after workpiece batch division, and taking a reciprocal of the completion time as a fitness function value of the genetic algorithm; and
S7: determining whether an iteration of the genetic algorithm satisfies a termination condition, if yes, outputting an optimal batch division solution and a scheduling strategy of the job-shop batch scheduling problem; and otherwise, selecting an optimal individual from the initial population through a roulette method to enter a next generation, and executing S3.

11. The job-shop batch scheduling method based on a D3QN and a genetic algorithm according to claim 10, wherein in S1, the mathematical model for job-shop batch scheduling is constructed as follows:
1-1. the job-shop batch scheduling problem is described as follows: supposing n types of workpieces to be machined on M machines in a shop, each type of workpieces is divided into a plurality of batches, a number of workpieces in each batch is randomly assigned, each batch of each type of workpieces contains J procedures, machining machines and a machining time of each procedure are known, a scheduling goal is to divide the workpieces in batches reasonably and arrange a machining order of the procedures of each batch, so as to minimize the maximum completion time;
1-2. symbols used in the mathematical model of the job-shop batch scheduling problem are described as follows:
n: number of types of workpieces to be machined;
m: a machining machine no., and m=1, 2, 3, . . . , M;
j: a procedure no. of workpieces i;
a total number of procedures of the workpieces i;
k: a batch no. of the workpieces i;
Bᵢ: a total number of the workpieces i;
Aₘₐₓ: a maximum number of batches of all workpieces;
Pᵢ: a number of batches of the workpieces i;
Sₜₖ: a number of the workpieces i in the kth batch;
Oᵢⱼ: a jth procedure of the workpieces i;
PTᵢⱼₘ: a time of machining of the jth procedure of the workpieces i on the machine m;
STᵢₖⱼₘ: a start time of machining of the jth procedure of the workpieces i in the kth batch on the machine m;
ETᵢₖⱼₘ: an end time of machining of the jth procedure of the workpieces i in the kth batch on the machine m;
Eₜₖₘ: an end time of machining of a last procedure of the workpieces i in the kth batch on the machine m;
Xᵢⱼₘ: a decision variable, which is 1 in case that the jth procedure of the workpieces i is machined on the machine m, and is 0 otherwise;
Cᵢ: a finish time of the workpieces i; and
Cₘₐₓ: a maximum completion time for all workpieces; and
1-3. according to definitions of the symbols, the mathematical model of the job-shop batch scheduling problem is established as follows:
an objective function is as follows:
$$min {C}_{max} = min max \{ {C}_{i} \vert i = 1 , 2 , … , n \} \qquad ( 1 )$$
constraint conditions are as follows:
$${\sum }_{k = 1}^{{P}_{i}} {S}_{ik} = {B}_{i} \qquad ( 2 )$$
$$1 \leq {P}_{i} \leq {A}_{max} \qquad ( 3 )$$
$${ET}_{ikjm} = {ST}_{ikjm} + {PT}_{ijm} \times {S}_{ik} \qquad ( 4 )$$
$${ST}_{ik ( j + 1 ) m} >= {ET}_{ikjm} \qquad ( 5 )$$
$${\sum }_{m = 1}^{M} {X}_{ijm} = 1 \qquad ( 6 )$$
$${C}_{max} = max \{ {C}_{i} \vert i = 1 , 2 , … , n \} \qquad ( 7 )$$
equation (1) indicates a minimum completion time after model optimization; equation (2) indicates that a sum of numbers of workpieces i in all batches must be equal to a total number of the workpieces i; equation (3) indicates that a number of batches divided is not greater than a pre-specified maximum number; equation (4) indicates that an end time of the jth procedure of the workpieces i in the kth batch on the machine m is equal to a sum of the start time of machining and a procedure machining time of the batch, wherein the procedure machining time of the batch is a product of a procedure machining time and a number of the workpieces in the batch; equation (5) indicates that a same workpiece is only machined after being machined in a previous procedure; equation (6) indicates that the jth procedure of the workpieces i is only performed on one machine; and equation (7) indicates that the maximum completion time is equal to a maximum finish time of all workpieces.

12. The job-shop batch scheduling method based on a D3QN and a genetic algorithm according to claim 11, wherein in S3, the crossing is to randomly generate a crossover position r, wherein 1≤r≤n, exchange chromosome genes corresponding to a workpiece numbered r in two parent chromosomes, and obtain two new chromosomes.

13. The job-shop batch scheduling method based on a D3QN and a genetic algorithm according to claim 12, wherein in S3, the mutating is to randomly generate a mutation position r, wherein 1≤r≤n, randomly select two positions of the chromosome genes corresponding to the workpiece numbered r, perform operations of adding 1 and subtracting 1, and obtain a new chromosome.

14. The job-shop batch scheduling method based on a D3QN and a genetic algorithm according to claim 12, wherein in S4, the disjunctive graph model of the procedure sequencing problem is constructed as follows:
4-1. a disjunctive graph G=(V,C∪D) is a mixed graph, wherein V represents a set of all machining procedure nodes; C represents a set of connecting arcs, that is, an order constraint relation between different procedures of a same workpiece; D represents a set of disjunctive arcs, and two procedure nodes connected to a same disjunctive arcs is machined on a same machine; and scheduling is regarded as determining a direction of all the disjunctive arcs in the graph and further minimizing the maximum completion time; and
4-2. according to a real-time state of a scheduling process, the following feature information is added to each procedure node in the disjunctive graph:
(1) a procedure state which is represented by a one-hot vector, wherein [1, 0, 0] means not completed, [0, 1, 0] means being machined, and [0, 0, 1] means completed;
(2) a procedure machining time;
(3) an estimated procedure finish time;
(4) a procedure waiting time;
(5) a remaining procedure machining time; and
(6) a workpiece procedure completion rate; and
time-related data are normalized, and values of the time-related data are mapped to [0, 1].

15. The job-shop batch scheduling method based on a D3QN and a genetic algorithm according to claim 13, wherein in S4, the disjunctive graph model of the procedure sequencing problem is constructed as follows:
4-1. a disjunctive graph G=(V,C∪D) is a mixed graph, wherein V represents a set of all machining procedure nodes; C represents a set of connecting arcs, that is, an order constraint relation between different procedures of a same workpiece; D represents a set of disjunctive arcs, and two procedure nodes connected to a same disjunctive arcs is machined on a same machine; and scheduling is regarded as determining a direction of all the disjunctive arcs in the graph and further minimizing the maximum completion time; and
4-2. according to a real-time state of a scheduling process, the following feature information is added to each procedure node in the disjunctive graph:
(1) a procedure state which is represented by a one-hot vector, wherein [1, 0, 0] means not completed, [0, 1, 0] means being machined, and [0, 0, 1] means completed;
(2) a procedure machining time;
(3) an estimated procedure finish time;
(4) a procedure waiting time;
(5) a remaining procedure machining time; and
(6) a workpiece procedure completion rate; and
time-related data are normalized, and values of the time-related data are mapped to [0, 1].

16. The job-shop batch scheduling method based on a D3QN and a genetic algorithm according to claim 14, wherein in S4, designing of the actions is to take 8 heuristic rules as an action space.

17. The job-shop batch scheduling method based on a D3QN and a genetic algorithm according to claim 15, wherein in S4, designing of the actions is to take 8 heuristic rules as an action space.

18. The job-shop batch scheduling method based on a D3QN and a genetic algorithm according to claim 14, wherein in S4, designing of the rewards is specifically calculated as follows:
$${r}_{t} = \{ \begin{matrix}{U}_{t} - {U}_{t - 1} & t \neq L \\ {U}_{t} - {U}_{t - 1} - ( makespan - {T}_{ini} ) / C & t = L\end{matrix} \qquad ( 8 )$$
wherein Uₜ represents a utilization rate of a machining machine at a moment t through a calculation method: a machining machine utilization rate=a total working time of the machining machine/(a current time−a time when a first procedure starts); and C is a constant related to a scheduling scale, makespan is an actual completion time of finishing all workpieces machined on the machine, Tᵢₙᵢ is an initial estimated completion time through a calculation method:
$${T}_{ini} = max ( {\sum }_{for all j} {T}_{i , j} , i ∈ ( 0 , 1 , 2 , … , n ) ) ,$$
and L is the completion time of the scheduling.

19. The job-shop batch scheduling method based on a D3QN and a genetic algorithm according to claim 15, wherein in S4, designing of the rewards is specifically calculated as follows:
$${r}_{t} = \{ \begin{matrix}{U}_{t} - {U}_{t - 1} & t \neq L \\ {U}_{t} - {U}_{t - 1} - ( makespan - {T}_{ini} ) / C & t = L\end{matrix} \qquad ( 8 )$$
wherein Uₜ represents a utilization rate of a machining machine at a moment t through a calculation method: a machining machine utilization rate=a total working time of the machining machine/(a current time−a time when a first procedure starts); and C is a constant related to a scheduling scale, makespan is an actual completion time of finishing all workpieces machined on the machine, Tᵢₙᵢ is an initial estimated completion time through a calculation method:
$${T}_{ini} = max ( {\sum }_{for all j} {T}_{i , j} , i ∈ ( 0 , 1 , 2 , … , n ) ) ,$$
and L is the completion time of the scheduling.

20. The job-shop batch scheduling method based on a D3QN and a genetic algorithm according to claim 18, wherein in S5, the representative learning is performed on the node feature information of the disjunctive graph by using the graph neural network, and a node representative calculation method is as follows:
$${h}_{v}^{( k )} = {f}_{θ}^{( k )} ( {f}_{o}^{( k )} ( {\sum }_{u ∈ {N}_{o} ( v )} {h}_{o}^{( k - 1 )} ) ‖ {f}_{d}^{( k )} ( {\sum }_{u ∈ {N}_{d} ( v )} {h}_{d}^{( k - 1 )} ) ‖ {h}_{v}^{( k - 1 )} ) \qquad ( 9 )$$
where hᵥ^{(k)} represents a kth-generation node feature of a target node v, hₒ represents a connecting arc node feature, and h_{d} represents a disjunctive arc node feature; f_{θ} represents an updating function of the target node v, fₒ represents a connecting arc node updating function, and f_{d} represents a disjunctive arc node updating function; ∥ represents a vector connector; and after K iterations, each node in the disjunctive graph includes a feature state of K-hop neighbor nodes, all of the node features in the graph are summed and averaged, and a feature state, that is, h_{G}=Σ_{u∈V}kᵥ^{K}/|V|, of the disjunctive graph is obtained.

21. The job-shop batch scheduling method based on a D3QN and a genetic algorithm according to claim 19, wherein in S5, the representative learning is performed on the node feature information of the disjunctive graph by using the graph neural network, and a node representative calculation method is as follows:
$${h}_{v}^{( k )} = {f}_{θ}^{( k )} ( {f}_{o}^{( k )} ( {\sum }_{u ∈ {N}_{o} ( v )} {h}_{o}^{( k - 1 )} ) ‖ {f}_{d}^{( k )} ( {\sum }_{u ∈ {N}_{d} ( v )} {h}_{d}^{( k - 1 )} ) ‖ {h}_{v}^{( k - 1 )} ) \qquad ( 9 )$$
where hᵥ^{(k)} represents a kth-generation node feature of a target node v, hₒ represents a connecting arc node feature, and h_{d} represents a disjunctive arc node feature; f_{θ} represents an updating function of the target node v, fₒ represents a connecting arc node updating function, and f_{d} represents a disjunctive arc node updating function; ∥ represents a vector connector; and after K iterations, each node in the disjunctive graph includes a feature state of K-hop neighbor nodes, all of the node features in the graph are summed and averaged, and a feature state, that is, h_{G}=Σ_{u∈V}kᵥ^{K}/|V|, of the disjunctive graph is obtained.

22. The job-shop batch scheduling method based on a D3QN and a genetic algorithm according to claim 18, wherein in S6, the training the D3QN model, and providing an adaptive scheduling strategy and completion time for the procedure sequencing problem of the workpiece batches after workpiece batch division specifically comprise:
6-1. initializing parameters: initializing a parameter θ of a current Q network, initializing a parameter θ⁻ of a target \hat{Q} network, and assigning the parameter of the Q network to the target \hat{Q} network, where θ→θ⁻, a total number of iteration rounds is T, a discount factor is γ, an exploration rate is ∈, an update frequency of the parameter of the target \hat{Q} network is P, an experience replay capacity is N, and priority experience replay parameters are α and β;
6-2. inputting a current state s into a D3QN, calculating a corresponding Q value of each action, and selecting an action a by means of a ∈-greedy algorithm, such that a system gives a reward r;
6-3. storing the current state s, the action a, the reward r and a next state s′ obtained in a training process into a priority experience replay pool in a form of quadruples (s, a, r, s′) which provide experience data for a subsequent scheduling decision;
6-4. selecting min-batch samples from an experience pool M through a priority experience replay method, and training the min-batch samples, wherein a probability that a sample j is selected is calculated as follows:
$$j \sim P ( j ) = \frac{{p}_{j}^{α}}{{\sum }_{k} {p}_{k}^{α}}$$
wherein α represents a priority weight, uniform sampling is performed when α=0, pⱼ represents a priority index whose value is related to |TD-error|, and a specific calculation formula of pⱼ is as follows:
$${δ}_{j} = {r}_{j} + γ \hat{Q} ( {s}_{j} , arg {max}_{a} Q ( {s}_{j + 1} , {a}_{j} ) ) - Q ( {s}_{j} , {a}_{j} ) \\ Pj = \vert δ j \vert + ∈$$
wherein δⱼ is a time difference error TD-error, ∈ is a small positive number that prevents a sampling probability from approaching zero and is configured to guarantee that all samples have a probability of being selected;
when priority sampling is performed, different samples are assigned different probabilities, an original desired distribution is changed accordingly, importance sampling is configured to eliminate a deviation, and the weight of the importance sampling is calculated as follows:
$${ω}_{j} = {( N \cdot {P}_{j} )}^{- β} / {max}_{i} {ω}_{i}$$
wherein β is a hyperparameter configured to adjust a degree of the deviation; and
data obtained by sampling are input into the D3QN model, a time difference error TD-error is calculated, and a priority in a priority replay experience mechanism is further updated;
6-5. calculating a loss function, and updating a weight parameter of the D3QN continuously through a random gradient descent method, wherein a calculation method of the loss function is as follows:
$$L = {( r + γ \hat{Q} ( {s}^{′} , arg {max}_{a ∈ A} Q ( {s}^{′} , a ; θ ) ; {θ}^{-} ) - Q ( s , a ; θ ) )}^{2}$$
wherein γ represents a discount factor; and
6-6. obtaining a final scheduling model of the procedure sequencing problem by training cyclically until cumulative rewards are converged.

23. The job-shop batch scheduling method based on a D3QN and a genetic algorithm according to claim 19, wherein in S6, the training the D3QN model, and providing an adaptive scheduling strategy and completion time for the procedure sequencing problem of the workpiece batches after workpiece batch division specifically comprise:
6-1. initializing parameters: initializing a parameter θ of a current Q network, initializing a parameter θ⁻ of a target \hat{Q} network, and assigning the parameter of the Q network to the target \hat{Q} network, where θ→θ⁻, a total number of iteration rounds is T, a discount factor is γ, an exploration rate is ∈, an update frequency of the parameter of the target \hat{Q} network is P, an experience replay capacity is N, and priority experience replay parameters are α and β;
6-2. inputting a current state s into a D3QN, calculating a corresponding Q value of each action, and selecting an action a by means of a ∈-greedy algorithm, such that a system gives a reward r;
6-3. storing the current state s, the action a, the reward r and a next state s′ obtained in a training process into a priority experience replay pool in a form of quadruples (s, a, r, s′) which provide experience data for a subsequent scheduling decision;
6-4. selecting min-batch samples from an experience pool M through a priority experience replay method, and training the min-batch samples, wherein a probability that a sample j is selected is calculated as follows
$$j \sim P ( j ) = \frac{{p}_{j}^{α}}{{\sum }_{k} {p}_{k}^{α}}$$
wherein α represents a priority weight, uniform sampling is performed when α=0, pⱼ represents a priority index whose value is related to |TD-error|, and a specific calculation formula of pⱼ is as follows:
$${δ}_{j} = {r}_{j} + γ \hat{Q} ( {s}_{j} , arg {max}_{a} Q ( {s}_{j + 1} , {a}_{j} ) ) - Q ( {s}_{j} , {a}_{j} ) \\ Pj = \vert δ j \vert + ∈$$
wherein δⱼ is a time difference error TD-error, ∈ is a small positive number that prevents a sampling probability from approaching zero and is configured to guarantee that all samples have a probability of being selected;
when priority sampling is performed, different samples are assigned different probabilities, an original desired distribution is changed accordingly, importance sampling is configured to eliminate a deviation, and the weight of the importance sampling is calculated as follows:
$${ω}_{j} = {( N \cdot {P}_{j} )}^{- β} / {max}_{i} {ω}_{i}$$
wherein β is a hypermeter configured to a degree of the deviation; and
data obtained by sampling are input into the D3QN model, a time difference error TD-error is calculated, and a priority in a priority replay experience mechanism is further updated;
6-5. calculating a loss function, and updating a weight parameter of the D3QN continuously through a random gradient descent method, wherein a calculation method of the loss function is as follows:
$$L = {( r + γ \hat{Q} ( {s}^{′} , arg {max}_{a ∈ A} Q ( {s}^{′} , a ; θ ) ; {θ}^{-} ) - Q ( s , a ; θ ) )}^{2}$$
wherein γ represents a discount factor; and
6-6. obtaining a final scheduling model of the procedure sequencing problem by training cyclically until cumulative rewards are converged.

24. The job-shop batch scheduling method based on a D3QN and a genetic algorithm according to claim 20, wherein in S6, the training the D3QN model, and providing an adaptive scheduling strategy and completion time for the procedure sequencing problem of the workpiece batches after workpiece batch division specifically comprise:
6-1. initializing parameters: initializing a parameter θ of a current Q network, initializing a parameter θ⁻ of a target \hat{Q} network, and assigning the parameter of the Q network to the target \hat{Q} network, where θ→θ⁻, a total number of iteration rounds is T, a discount factor is γ, an exploration rate is ∈, an update frequency of the parameter of the target \hat{Q} network is P, an experience replay capacity is N, and priority experience replay parameters are α and β;
6-2. inputting a current state s into a D3QN, calculating a corresponding Q value of each action, and selecting an action a by means of a ∈-greedy algorithm, such that a system gives a reward r;
6-3. storing the current state s, the action a, the reward r and a next state s′ obtained in a training process into a priority experience replay pool in a form of quadruples (s, a, r, s′) which provide experience data for a subsequent scheduling decision;
6-4. selecting min-batch samples from an experience pool M through a priority experience replay method, and training the min-batch samples, wherein a probability that a sample j is selected is calculated as follows:
$$j \sim P ( j ) = \frac{{p}_{j}^{α}}{{\sum }_{k} {p}_{k}^{α}}$$
wherein α represents a priority weight, uniform sampling is performed when α=0, pⱼ represents a priority index whose value is related to |TD-error|, and a specific calculation formula of pⱼ is as follows:
$${δ}_{j} = {r}_{j} + γ \hat{Q} ( {s}_{j} , arg {max}_{a} Q ( {s}_{j + 1} , {a}_{j} ) ) - Q ( {s}_{j} , {a}_{j} ) \\ Pj = \vert δ j \vert + ∈$$
wherein δⱼ is a time difference error TD-error, ∈ is a small positive number that prevents a sampling probability from approaching zero and is configured to guarantee that all samples have a probability of being selected;
when priority sampling is performed, different samples are assigned different probabilities, an original desired distribution is changed accordingly, importance sampling is configured to eliminate a deviation, and the weight of the importance sampling is calculated as follows:
$${ω}_{j} = {( N \cdot {P}_{j} )}^{- β} / {max}_{i} {ω}_{i}$$
wherein β is a hyperparameter configured to adjust a degree of the deviation; and
data obtained by sampling are input into the D3QN model, a time difference error TD-error is calculated, and a priority in a priority replay experience mechanism is further updated;
6-5. calculating a loss function, and updating a weight parameter of the D3QN continuously through a random gradient descent method, wherein a calculation method of the loss function is as follows:
$$L = {( r + γ \hat{Q} ( {s}^{′} , arg {max}_{a ∈ A} Q ( {s}^{′} , a ; θ ) ; {θ}^{-} ) - Q ( s , a ; θ ) )}^{2}$$
wherein γ represents a discount factor; and
6-6. obtaining a final scheduling model of the procedure sequencing problem by training cyclically until cumulative rewards are converged.

25. The job-shop batch scheduling method based on a D3QN and a genetic algorithm according to claim 21, wherein in S6, the training the D3QN model, and providing an adaptive scheduling strategy and completion time for the procedure sequencing problem of the workpiece batches after workpiece batch division specifically comprise:
6-1. initializing parameters: initializing a parameter θ of a current Q network, initializing a parameter θ⁻ of a target \hat{Q} network, and assigning the parameter of the Q network to the target \hat{Q} network, where θ→θ⁻, a total number of iteration rounds is T, a discount factor is γ, an exploration rate is ∈, an update frequency of the parameter of the target \hat{Q} network is P, an experience replay capacity is N, and priority experience replay parameters are α and β;
6-2. inputting a current state s into a D3QN, calculating a corresponding Q value of each action, and selecting an action a by means of a ∈-greedy algorithm, such that a system gives a reward r;
6-3. storing the current state s, the action a, the reward r and a next state s′ obtained in a training process into a priority experience replay pool in a form of quadruples (s, a, r, s′) which provide experience data for a subsequent scheduling decision;
6-4. selecting min-batch samples from an experience pool M through a priority experience replay method, and training the min-batch samples, wherein a probability that a sample j is selected is calculated as follows:
$$J \sim P ( j ) = \frac{{p}_{j}^{α}}{{\sum }_{k} {p}_{k}^{α}}$$
wherein α represents a priority weight, uniform sampling is performed when α=0, pⱼ represents a priority index whose value is related to |TD-error|, and a specific calculation formula of pⱼ is as follows:
$${δ}_{j} = {r}_{j} + γ \hat{Q} ( {s}_{j} , arg {max}_{a} Q ( {s}_{j + 1} , {a}_{j} ) ) - Q ( {s}_{j} , {a}_{j} ) \\ Pj = \vert δ j \vert + ∈$$
wherein δⱼ is a time difference error TD-error, ∈ is a small positive number that prevents a sampling probability from approaching zero and is configured to guarantee that all samples have a probability of being selected;
when priority sampling is performed, different samples are assigned different probabilities, an original desired distribution is changed accordingly, importance sampling is configured to eliminate a deviation, and the weight of the importance sampling is calculated as follows:
$${ω}_{j} = {( N \cdot {P}_{j} )}^{- β} / {max}_{i} {ω}_{i}$$
wherein β is a hyperparameter configured to adjust a degree of the deviation; and
data obtained by sampling are input into the D3QN model, a time difference error TD-error is calculated, and a priority in a priority replay experience mechanism is further updated;
6-5. calculating a loss function, and updating a weight parameter of the D3QN continuously through a random gradient descent method, wherein a calculation method of the loss function is as follows:
$$L = {( r + γ \hat{Q} ( {s}^{′} , arg {max}_{a ∈ A} Q ( {s}^{′} , a ; θ ) ; {θ}^{-} ) - Q ( s , a ; θ ) )}^{2}$$
wherein γ represents a discount factor; and
6-6. obtaining a final scheduling model of the procedure sequencing problem by training cyclically until cumulative rewards are converged.
